(19) United States
(12) Patent Application Publication
(10) Pub. No.: US 2004/0050601 A1
(43) Pub. Date: Mar. 18, 2004

(54) Engine partition

(76) Inventor: Basil Tsiaousopoulos, Winchester, MA (US)

Correspondence Address: WOOD, HERRON & EVANS, LLP, 2700 CAREW TOWER, 441 VINE STREET, CINCINNATI, OH, 45202, US

(21) Appl. No.: 10/242,643

(22) Filed: Sep. 12, 2002

(51) Int. Cl. B62D 25/10

(52) U.S. Cl. 180/69.22

(57) ABSTRACT

A partition for adjusting noise emanating from the engine compartment of a vehicle. The partition is provided for installation over the engine compartment of a vehicle and may comprise an opening integrally formed therein, a conduit communicating with the orifice, and a movable panel, the movable panel being operatively connected with the conduit. The panel can be moved manually or by mechanical or electrical remote actuation. The partition can be light transmissive, and a light source can be disposed proximate to the partition for illuminating the engine compartment.

### FIELD OF THE INVENTION

The present invention relates generally to a noise suppression apparatus and, more particularly, to a partition for adjusting noise emanating from the engine compartment of a vehicle.

### BACKGROUND OF THE INVENTION

In recent years, the customizing of vehicles has increased in interest. For example, it has become popular with vans to cut holes in the sidewalls and mount windows therein of any desired configuration. It has also become popular in automobiles to provide opera windows. For example, in U.S. Pat. No. 3,776,591, there is disclosed a method and apparatus for installing an opera window in a quarter panel of an automobile having an opening cut therein. In addition, in U.S. Pat. No. 4,153,291, there is disclosed a viewport assembly for installation in the hood of a vehicle which may be easily and inexpensively installed in the front or rear hood of a vehicle and thereby provide the vehicle with a distinctive and sporty feature to enhance the appearance of the vehicle. Accordingly, it will be understood that there have been many attempts in the past to improve the distinctive and sporty features of vehicles. It is therefore highly desirable to provide other arrangements for inexpensively enhancing the distinctiveness and/or the sportiness of vehicles.

Conventional attempts to enhance the distinctiveness and/or the sportiness of vehicles have primarily been limited to customizing the appearance of vehicles. These conventional attempts typically consist of viewport assemblies which may be transparent or translucent and which may allow for viewing of the engine. Efforts to enhance the distinctiveness and/or the sportiness of vehicles have also related to altering the noise level emanating from the engine compartment from one fixed noise level to another fixed noise level. The object of these arrangements has been generally directed to altering noise levels by reducing the noise level emanating from the engine compartment from one fixed noise level to a lower fixed noise level. Once the noise level emanating from the engine compartment has been reduced to this lower noise level, these arrangements do not allow for adjusting noise levels by varying the noise level emanating from the engine compartment. These arrangements also do not allow for adjusting noise levels by varying the noise level emanating from the engine compartment to a higher noise level quickly and easily, while permitting viewing of the engine. For car enthusiasts, the distinctiveness and sportiness of a vehicle are enhanced by adjusting noise levels by varying the sounds produced by the engine and emanating from the engine compartment. In addition, the distinctiveness and sportiness of a vehicle are enhanced by adjusting noise levels by varying the sounds produced by the engine and emanating from the engine compartment to a higher noise level quickly and easily.

Broadly, it is an object of the present invention to provide an engine compartment partition to adjust noise levels by varying the noise emanating from an engine compartment of a vehicle which may be easily and inexpensively installed and thereby enhance the distinctiveness and/or the sportiness of vehicles.

### SUMMARY OF THE INVENTION

The present invention overcomes the foregoing and other shortcomings and drawbacks of inventions for altering the noise level emanating from the engine compartment of a vehicle from one fixed noise level to a lower fixed noise level and methods heretofore known. While the invention will be described in connection with certain embodiments, it will be understood that the invention is not limited to these embodiments. On the contrary, the invention includes all alternatives, modifications and equivalents as may be included within the spirit and scope of the present invention.

In accordance with the present invention, there is provided an engine compartment partition for varying the noise level emanating from an engine compartment of a vehicle. In one embodiment consistent with the principles of the present invention, the engine compartment partition is provided with a partition for installation over the engine compartment of a vehicle, wherein the partition is provided with an opening formed by the partition. The engine compartment partition further includes a conduit which may be supported by the partition. The conduit is provided with first and second ends, wherein the first end communicates with the opening formed by the partition. It should be understood that the second end of the conduit may communicate with the environment or the passenger compartment of the vehicle. The engine compartment partition is also provided with a movable panel, wherein the panel is operatively connected to the conduit. The panel is also selectively movable relative to the conduit for varying the noise emanating from the engine compartment of the vehicle. It should be understood that the panel may be moved manually or by mechanical or electrical remote actuation.

In an alternative embodiment, there is provided an engine compartment partition provided with a partition for installation over the engine compartment of a vehicle. The engine compartment partition is further provided with support members for supporting the partition. The partition may be operable to move or slide relative to the support members. In this embodiment, the need for a conduit is eliminated. Further, in this embodiment, the need for a movable panel is eliminated.

In still another embodiment, there is provided an engine compartment partition provided with a partition for installation over the engine compartment of a vehicle, wherein the partition is provided with an opening formed by the partition. The engine compartment partition further includes a panel which may be provided for installation over the opening formed by the partition. It should be understood that the panel may be operatively connected to the partition and the panel may further be selectively movable for varying the noise emanating from the engine compartment of the vehicle.

It should be understood that the engine compartment partition may be located in either the front or the rear of the vehicle, or may be located mid-engine, and that there would be a number of advantages in installing an engine compartment partition in accordance with the present invention over the engine compartment of a vehicle. More particularly, the engine compartment partition may take a variety of shapes and designs to further enhance the distinctiveness and sportiness of a vehicle. Further, the partition, conduit, and/or panel may be light transmissive or transparent so that the vehicle engine is visible, or the partition, conduit, and/or panel may be translucent. Accordingly, the distinctiveness and sportiness of a vehicle can be enhanced by installing an engine compartment partition in accordance with the present invention, which is relatively easy and inexpensive to install.

It should also be understood that the engine compartment partition of the present invention may be installed on any type of vehicle, including automobiles, vans, pick-up trucks, jeeps, or the like, wherein the owner is desirous of enhancing the distinctiveness and/or sportiness of the vehicle. In addition, it should be understood that the engine compartment partition may be injection molded in the desired configuration, or manufactured in any other suitable manner. It should be further understood that the conduit may be integrally formed with the partition.

A further advantage of the present invention resides in the fact that the engine compartment partition may be provided with a filter disposed within the conduit. In this manner, engine by-products emanating from the engine compartment may be reduced while the noise emanating from the engine compartment may be varied. Further, the engine compartment partition may be provided with a light source disposed proximate to the partition, wherein the light source illuminates the engine compartment and engine.

Various advantages, objectives, and features of the invention will become more readily apparent to those of ordinary skill in the art upon review of the following detailed description of the preferred embodiments, taken in connection with the accompanying drawings.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a partial perspective view of an engine compartment partition in accordance with one embodiment of the present invention, which consistent with aspects of the invention, includes a partition, a conduit supported by the partition and having first and second ends, and a panel operatively connected to the conduit.

FIG. 2 is a perspective view of an engine compartment partition constructed according to the present invention.

FIG. 3 is partial perspective view of another embodiment of an engine compartment partition in which the conduit is operatively connected to the passenger compartment of a vehicle.

FIG. 4 is a partial perspective view of another embodiment of an engine compartment partition in which the conduit is operatively connected to the passenger compartment of a vehicle.

FIG. 5 is a partial perspective view of still another embodiment of an engine compartment partition in which the conduit is operatively connected to the passenger compartment of a vehicle.

FIG. 6 is a perspective view of another embodiment of an engine compartment partition, which consistent with the aspects of the invention, includes a partition and support members for supporting the partition.

FIG. 7 is a perspective view of another embodiment of an engine compartment partition constructed according to the present invention.

FIG. 8 is an enlarged sectional view of the conduit and panel as seen on line 8-8 of FIG. 1.

### DETAILED DESCRIPTION OF SPECIFIC EMBODIMENTS

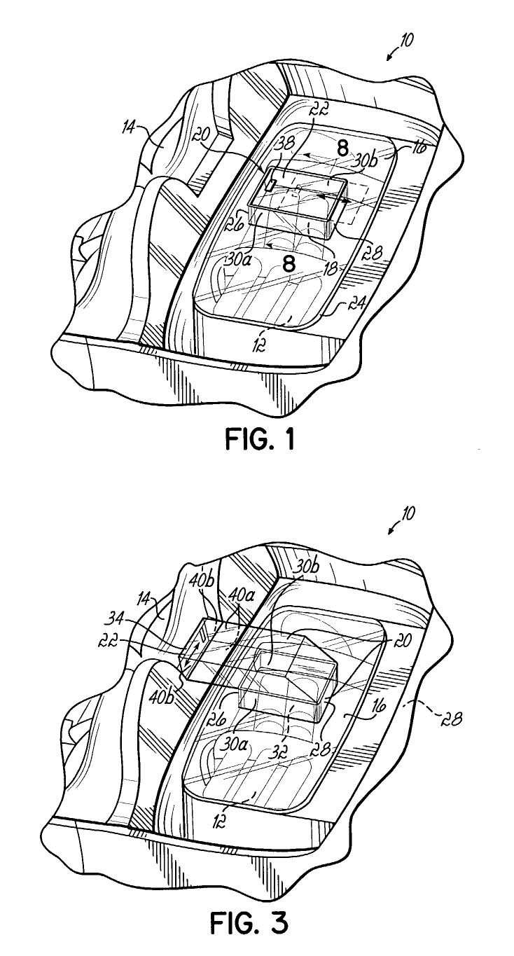

With reference to FIG. 1, an engine compartment partition 10 of the present invention is shown for a vehicle with an engine compartment 12 positioned in the rear of the vehicle or positioned mid-engine, and proximate to the passenger compartment 14 of the vehicle. The engine compartment partition 10 comprises a partition 16 overlying the engine compartment 12 of the vehicle and having opening 18 formed by the partition 16, a conduit 20 communicating with the opening 18 formed by the partition 16, and a panel 22 operatively connected to the conduit 20. Each of these components is described in detail below.

As shown in FIG. 1, partition 16 is adapted to be mounted over the engine compartment 12 of the vehicle in a generally horizontally oriented position either as original equipment or as a retrofit item to be incorporated into the vehicle. The outer edge 24 of partition 16 is provided with a contour generally following the contour of the portion of the body of the vehicle defining the engine compartment 12 of the vehicle. Partition 16 may be secured to the portion of the body of the vehicle defining the engine compartment 12 of the vehicle by spaced bolts or other fasteners. An opening 18 in partition 16 is formed by the partition 16.

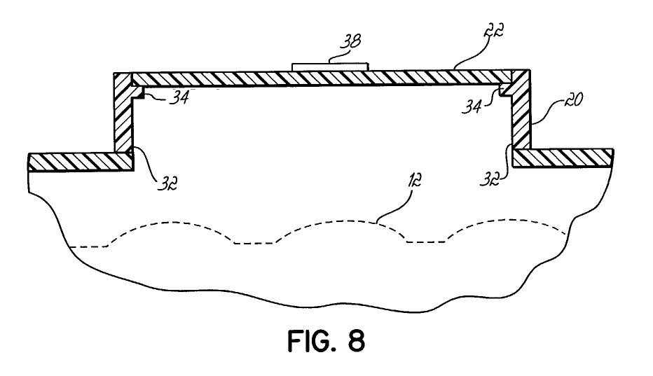

The engine compartment partition 10 further comprises a conduit 20 communicating with the opening 18 formed by partition 16. Conduit 20 is defined by a front wall 26 and a rear wall 28 extending upwardly from the opening 18 formed by partition 16 and positioned generally parallel to each other. Conduit 20 is further defined by a pair of side walls 30a and 30b extending upwardly from the opening 18 formed by partition 16. Side walls 30a and 30b are positioned generally parallel to each other and further positioned generally perpendicular to front wall 26 and rear wall 28. Referring to FIG. 8, conduit 20 is further defined by a first end 32 and a second end 34. The first end 32 of conduit 20 is secured to the opening 18 formed by partition 16. The second end 34 of conduit 20 is adapted to receive a panel 22, the panel 22 being described in more detail below.

The engine compartment partition 10 further comprises a panel 22 adapted to be operatively connected to the second end 34 of the conduit 20. The panel 22 is selectively movable relative to the conduit 20 in a generally horizontal plane. The panel 22 has formed therein a handle or recess 38 for selectively moving the panel 22 relative to the conduit 20.

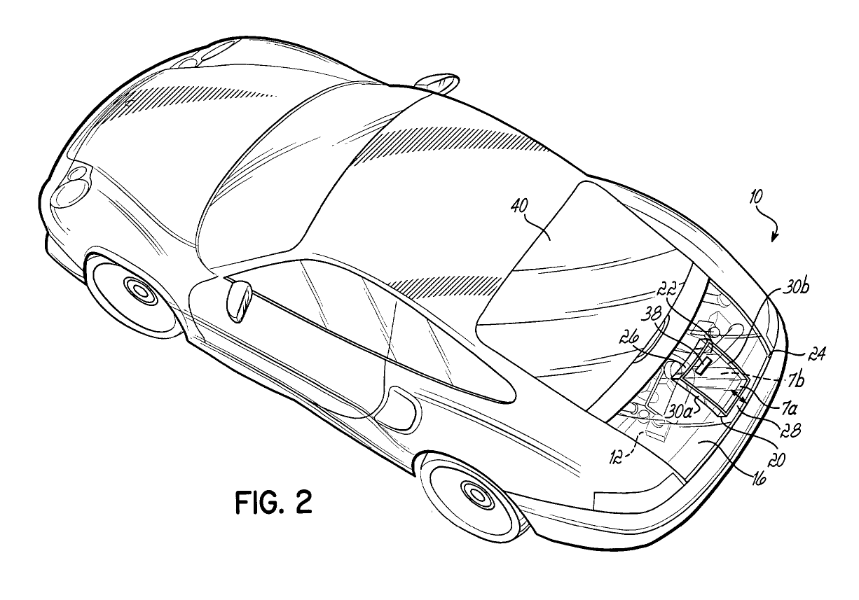

With reference to FIG. 2, an engine compartment partition 10 of the present invention is shown for a vehicle with an engine compartment 12 positioned in the rear of the vehicle proximate to the tail of the vehicle. Similar to the engine compartment partition 10 described in FIG. 1, the engine compartment partition 10 comprises a partition 16 overlying the engine compartment 12 of the vehicle and having opening 18 formed by partition 16, a conduit 20 communicating with the opening 18 formed by partition 16, and a panel 22 operatively connected to the conduit 20. Each of these components is described in detail below.

As shown in FIG. 2, partition 16 is adapted to be mounted over the engine compartment 12 of the vehicle and generally oriented in the same plane as the hood 40 of the vehicle. In this respect, the outer surface of the partition 16 may be adapted to follow the curvature of the hood 40 of the vehicle. The partition 16 may be mounted as either original equipment or as a retrofit item to be incorporated into the vehicle. The outer edge 24 of the partition 16 is provided with a contour generally following the contour of the portion of the body of the vehicle defining the engine compartment 12 of the vehicle. The partition 16 may be secured to the portion of the body of the vehicle defining the engine compartment 12 of the vehicle by spaced bolts or other fasteners. An opening 18 in partition 16 is formed by partition 16.

The engine compartment partition 10 further comprises a conduit 20 communicating with the opening 18 formed by partition 16. Conduit 20 is defined by a front wall 26 and a rear wall 28 extending generally perpendicular from the partition 16 and positioned generally parallel to each other. The conduit 20 is further defined by a pair of side walls 30a and 30b extending generally perpendicular from the partition 16 and positioned generally parallel to each other and further positioned generally perpendicular to the front wall 26 and the rear wall 28. Conduit is further defined by a first end 32 and a second end 34. The first end 32 of the conduit 20 is secured to the opening 18 formed by the partition 16. The second end 34 of the conduit 20 is adapted to receive a panel 22, the panel 22 being described in more detail below.

The engine compartment 10 partition further comprises a panel 22 adapted to be operatively connected to the second end 34 of the conduit 20. The panel 22 is selectively movable relative to the conduit 20 in a plane generally parallel to the plane defined by the curvature of the hood 40 of the vehicle. The panel 22 has formed therein a handle or recess 38 for selectively moving the panel 22 relative to the conduit 20.

With reference to FIG. 3, an engine compartment partition 10 of the present invention is shown for a vehicle with an engine compartment 12 positioned in the rear of the vehicle or positioned mid-engine, and proximate to the passenger compartment 14 of the vehicle. The engine compartment partition 10 comprises a partition 16 overlying the engine compartment 12 of the vehicle and having opening 18 formed by partition 16, a conduit 20 with a first end 32 communicating with the opening 18 formed by partition 16 and a second end 34 operatively connected to the passenger compartment 14 of a vehicle, and a panel 22 operatively connected to the conduit 20. Each of these components is described in detail below.

As shown in FIG. 3, partition 16 similar in all respects to partition 16 described with reference to FIG. 1 is provided.

As further shown in FIG. 3, conduit 20 similar to the conduit described with reference to FIG. 1 is particularly adapted such that the second end 34 of conduit 20 may be operatively connected to the passenger compartment 14 of a vehicle. Conduit 20 similar to the conduit 20 described with reference to FIG. 1 is particularly adapted by further providing a first pair of transverse walls 40a oriented generally transverse to the front wall 26, rear wall 28, and pair of side walls 30a and 30b defining the conduit 20 described with reference to FIG. 1. As can be further seen by reference to FIG. 3, the conduit 20 described in FIG. 3 is further provided with a second pair of transverse walls 40a oriented generally transverse to the front wall 26, rear wall 28, and pair of side walls 30a and 30b defining the conduit 20 described with reference to FIG. 1 and further oriented generally perpendicular to the first pair of transverse walls 40a. In this regard, the first pair of transverse walls 40a and the second pair of transverse walls 40a of the conduit 20 described in FIG. 3 extend generally outwardly from the passenger compartment 14 of the vehicle and generally toward the rear of the vehicle.

As further shown in FIG. 3, the engine compartment partition 10 further comprises a panel 22 adapted to be operatively connected to the second end 34 of conduit 20. The panel 22 is selectively movable relative to conduit 20. It should be understood that panel 22 may be disposed over the first end 32 of conduit 20, over the second end 34 of conduit 20 as described in FIG. 3, or within conduit 20 between the first and second ends of the conduit 20. The panel 32 has formed therein a handle or recess 38 for selectively moving the panel 22 relative to the conduit 20.

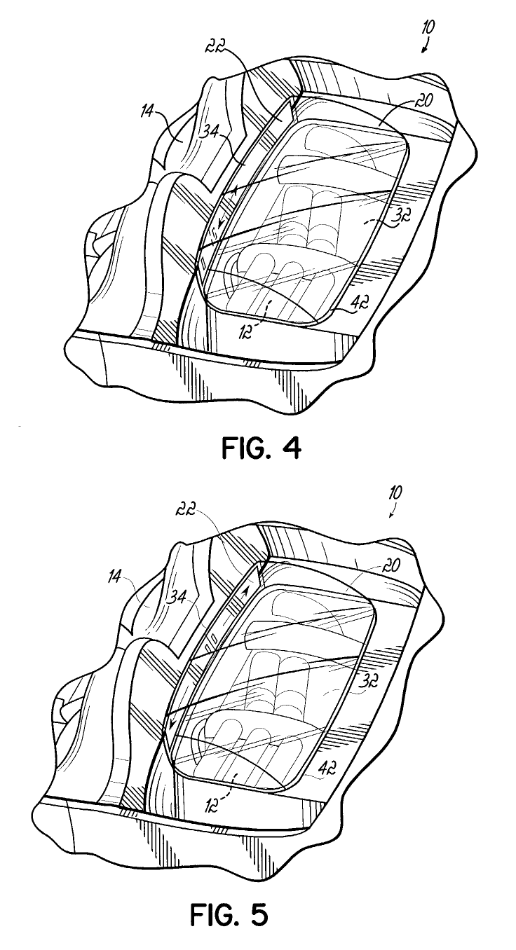

With reference to FIGS. 4 and 5, an engine compartment partition 10 of the present invention is shown for a vehicle with an engine compartment 12 positioned in the rear of the vehicle or positioned mid-engine, and proximate to the passenger compartment 14 of the vehicle. The engine compartment partition 10 comprises a conduit 20 having a first end 32 overlying the engine compartment 12 of the vehicle and a second end 34 operatively connected to the passenger compartment 14 of a vehicle, and a panel 22 operatively connected to the conduit 20.

As shown in FIGS. 4 and 5, conduit 20 is adapted to have a first end 32 overlying the engine compartment 12 of the vehicle and a second end 34 operatively connected to the passenger compartment 14 of a vehicle. The outer edge 42 of first end 32 of conduit 20 is provided with a contour generally following the contour of the portion of the body of the vehicle defining the engine compartment 12 of the vehicle. Conduit 20 is further provided with a second end 34 operatively connected to the passenger compartment 14 of the vehicle. It should be understood that conduit 20 may be provided in alternative configurations according to the present invention.

As further shown in FIGS. 4 and 5, the engine compartment partition 10 further comprises a panel 22 adapted to be operatively connected to the second end 34 of conduit 20. The panel 22 is selectively movable relative to the conduit 20. As can be seen in FIGS. 4 and 5, panel 22 may be provided in alternative configurations according to the present invention.

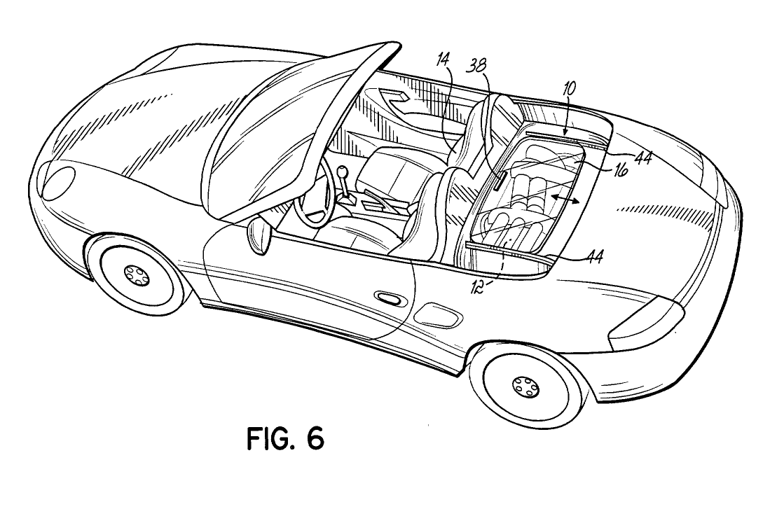

FIG. 6 illustrates still another embodiment of the present invention. In this embodiment, the engine compartment partition 10 is provided with support members 44 adapted to be mounted over engine compartment 12 of the vehicle. The support members 44 are further adapted to receive partition 16, which is described in more detail below. The support members 44 may be secured to the engine compartment 12 of the vehicle by way of spaced bolts or other fasteners.

As further shown in FIG. 6, the engine compartment partition 10 further comprises a partition 16 overlying the engine compartment 12 of the vehicle and adapted to be supported by the support members 44. Partition 16 is adapted to be selectively movable relative to the support members 44. In this embodiment, partition 16 may have formed therein a handle or recess 38 for selectively moving the partition 16 relative to the support members 44.

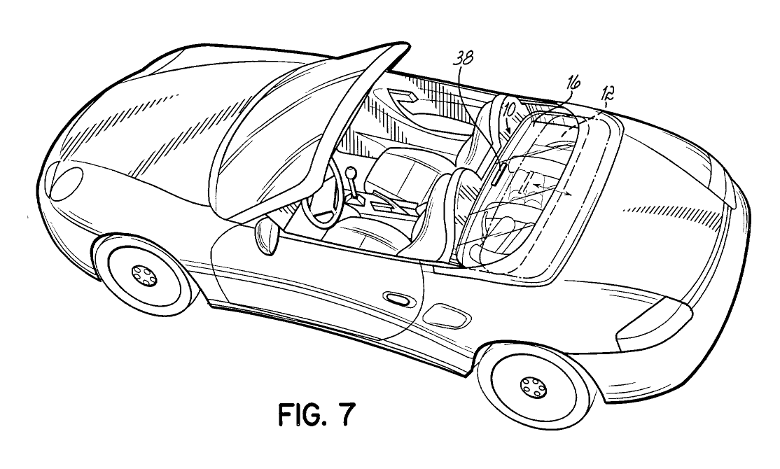

FIG. 7 illustrates still another embodiment in accordance with the present invention. In this embodiment, the engine compartment partition 10 is provided with a partition 16 overlying the engine compartment 12 of the vehicle. A salient difference between the embodiment illustrated in FIG. 7 and the embodiment illustrated in FIG. 6, is that the portion of the body of the vehicle defining the engine compartment of the vehicle is adapted to support partition 16. Partition 16 is adapted to be selectively movable relative to the engine compartment 12. In this embodiment, the partition 16 may have formed therein a handle or recess 38 for selectively moving the partition 16 relative to the engine compartment 12.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

Having described the invention, what is claimed is:

1. A device operable to adjust noise emanating from an engine compartment of a vehicle, comprising:
a partition overlying an engine compartment of a vehicle and having an opening formed by said partition;
a conduit supported by said partition and having first and second ends, said first end of said conduit communicating with said opening and said end defining an opening; and
a panel operatively connected to said conduit and being selectively movable to open and close said opening at said second end of said conduit to adjust noise emanating from said engine compartment of said vehicle.

2. The device of claim 1, wherein said panel is disposed over said first end of said conduit.

3. The device of claim 1, wherein said panel is disposed over said second end of said conduit.

4. The device of claim 1, wherein said panel is disposed within said conduit between said first and second ends.

5. The device of claim 1, wherein at least said partition is transparent.

6. The device of claim 1, wherein said panel is movable between a first and second position.

7. The device of claim 6, wherein said conduit is closed when said panel is in said first position.

8. The device of claim 6, wherein said conduit is open when said panel is in said second position.

9. The device of claim 6, wherein said conduit is integrally formed with said partition.

10. The device of claim 6, further comprising a filter disposed within said conduit.

11. The device of claim 6, further comprising at least one light source disposed proximate to said partition, wherein said light source illuminates said engine compartment.

12. The device of claim 9, further comprising a filter disposed within said conduit.

13. The device of claim 9, further comprising at least one light source disposed proximate to said partition, wherein said light source illuminates said engine compartment.

14. The device of claim 1, wherein said second end is operatively connected to a passenger compartment of said vehicle.

15. The device of claim 14, wherein said panel is disposed over said first end of said conduit.

16. The device of claim 14, wherein said panel is disposed over said second end of said conduit.

17. The device of claim 14, wherein said panel is disposed within said conduit between said first and second ends.

18. The device of claim 14, wherein said conduit is integrally formed with said partition.

19. The device of claim 14, wherein said panel is located between said engine compartment and said passenger compartment of said vehicle.

20. The device of claim 14, further comprising a filter disposed within said conduit.

21. The device of claim 20, wherein said filter reduces engine byproducts.

22. A device suitable for adjusting noise emanating from an engine compartment of a vehicle, the device comprising:
a support; and
a retractable partition overlying said engine compartment of said vehicle and attached to said support and being operable to slide relative to said support while remaining attached to said support to adjust noise emanating from said engine compartment of said vehicle.

23. The device of claim 22, wherein said partition is flexibly retractable.

24. The device of claim 22, wherein at least said partition is transparent.

25. The device of claim 22, further comprising at least one light source disposed proximate to said partition, wherein said light source illuminates said engine compartment.

26. A device suitable for adjusting noise emanating from an engine compartment of a vehicle, the device comprising:
a partition overlying said engine compartment of said vehicle, said partition having an opening formed by said partition; and
a retractable panel overlying said opening and attached to said partition and being operable to slide relative to said partition while remaining attached to said partition to adjust noise emanating from said engine compartment of said vehicle.

27. The device of claim 26, wherein said panel is flexibly retractable.

28. The device of claim 26, wherein at least said partition is transparent.

29. The device of claim 26, further comprising at least one light source disposed proximate to said partition, wherein said light source illuminates said engine compartment.

30. A vehicle comprising:
an engine compartment;
an engine which generates noise when operated;
a passenger compartment separate from said engine compartment;
a partition having an opening formed by said partition, said partition overlying an engine compartment of said vehicle;
a conduit having first and second ends, said first end disposed over said opening and said end defining an opening; and
a panel operatively connected to said conduit and being selectively movable to open and close said opening at said second end of said conduit to adjust noise emanating from said engine compartment of said vehicle.

31. The vehicle of claim 30, wherein said panel is movable between a first and second position.

32. The vehicle of claim 30, wherein said conduit is integrally formed with said partition.

33. The vehicle of claim 30, wherein said second end is operatively connected to said passenger compartment of said vehicle.

34. A device operable to adjust noise emanating from an engine compartment of a vehicle, comprising:
a conduit overlying an engine compartment of a vehicle and having first and second ends, said first end of said conduit communicating with said engine compartment and said end defining an opening; and
a panel operatively connected to said conduit and being selectively movable to open and close said opening at said second end of said conduit to adjust noise emanating from said engine compartment of said vehicle.
